(19) United States
(12) Patent Application Publication
(10) Pub. No.: US 2006/0290494 A1
(43) Pub. Date: Dec. 28, 2006

(54) System and method for detecting an object on a cart

(76) Inventor: Graeme O'Brien, Kitchener (CA)

Correspondence Address: BERESKIN AND PARR, 40 KING STREET WEST, BOX 401, TORONTO, ON, M5H 3Y2, CA

(21) Appl. No.: 11/166,002

(22) Filed: Jun. 27, 2005

(51) Int. Cl. G08B 13/14

(52) U.S. Cl. 340/568.5

(57) ABSTRACT

A system and method for detecting an object on a cart, including a support structure, a cart detector and an object detector provided to the support structure and an alert device. The cart detector including a first sensor and a second sensor that are positioned to detect predetermined cart portions as a cart transitions from the first sensor to the second sensor. The object detector including a third sensor and a fourth sensor positioned to approximately simultaneously detect an object on the cart while not detecting upright elements of the cart. Preferably, the cart sensors and object sensors also measure distances to obstructions so that the distances can also be analyzed to determine that a cart and/or object is present.

### FIELD OF THE INVENTION

Embodiments of the invention relate generally to the field of detecting objects on carts and, more particularly, to the field of detecting objects on a lower tray of a shopping cart.

### BACKGROUND OF THE INVENTION

Carts are used for moving objects around in various environments and there is often a need to detect if an object is on a cart as the cart passes a specific point. There is also often a need to alert a person that an object is on a cart, particularly when the object is on a lower part of the cart that is out of the line of sight of an observer.

Shopping carts used in grocery stores or other retail stores often have lower trays where larger or heavier items can be placed during shopping for increased convenience to the customer. These lower trays are beneficial to stores and customers as they allow customers to carry more items and generally provide a customer with the ability to purchase more items during a shopping trip. Unfortunately, these lower trays are often concealed from the cashier at the time of checkout, for example due to the poor viewing position of a cashier or the positioning of the cashier with respect to the checkout lane. Items on these lower trays may be forgotten about or purposely hidden by customers, and if not seen by the cashier will not be paid for, resulting in losses to store owners.

Some proposed solutions to this problem involve a person such as a cashier observing the lower tray of the shopping cart during checkout, either by mounting mirrors across the checkout lane such that the cashier can examine the lower tray, or by directing cameras at the lower tray and displaying the resulting images on a display screen for the cashier to monitor. These solutions may not be reliable, as they depend on the attentiveness of the cashier or the person observing the system, who may be distracted or inattentive.

Other proposed solutions actively interact with the object on the lower tray, for example by relying on the weight of the object to deflect the lower tray enough to allow a reflector mounted to the lower tray to be detected by a sensor in the checkout lane. Such solutions may not work effectively with objects of different weights, or objects incorrectly placed on the tray Furthermore, they require specialized carts to be used, and may be vulnerable to tampering or damage.

Other solutions have proposed scanning the lower tray of a shopping cart for the presence of objects using a collection of sensors. However, such systems generally require a triggering mechanism to first determine that a shopping cart is present and may have difficulty distinguishing between shopping carts and other objects moving through the checkout lane, resulting in a number of false alerts. Some systems use reflectors mounted on the shopping cart in combination with sensors in the checkout lane to detect that a cart is present. However, reflectors mounted on the carts can be blocked or broken, and may be subject to tampering.

Other proposed systems use an emitter mounted on the cart, such as an infrared transmitter, to signal the presence of an item on the lower tray of the cart. However, this signal can be blocked or disabled, and generally requires specialized equipment mounted to the cart, including generally a power source, and can be damaged, is vulnerable to tampering, and adds to the overall cost of the system as each shopping cart must be modified.

Other systems propose detecting two or more parts of a shopping cart simultaneously to determine its presence in a checkout lane. In one example, a system scans for the wheels of the shopping cart to determine that a shopping cart is present. However, such systems generally have difficultly sensing carts of different shapes and sizes, or if carts are angled in the checkout lane, and may only detect objects while the cart is in an exact position.

Other proposed systems for detecting objects on carts use beam obstruction technology in their design to determine when a cart or an object is present, using a beam emitter located across from a beam detector. When any object physically moves between an emitter and a detector, the sensors will output that an object has been detected. These systems typically require at least two surfaces opposing each other where the emitters and the detectors can be mounted to function properly. Also, beam emitters are generally unable to accurately determine that an object actually is on a cart, and may give a number of false alerts.

Though systems for detecting object on carts exist, they generally fail to ensure accurate and reliable detection of objects on the lower tray of a shopping cart. Conventional systems can be unreliable, inaccurate, and costly, and may require active human monitoring in order to adequately protect against the loss or theft of objects left on the lower trays of shopping carts.

As such, there is a need in the art to provide an improved system and method of actively, accurately and reliably detecting the presence of objects on the lower tray of a shopping cart.

### SUMMARY OF THE INVENTION

Embodiments of this invention are intended to overcome at least some of the problems with conventional systems and methods.

According to one embodiment of the invention there is provided a system for detecting an object on a cart, including: a support structure; a cart detector provided to the support structure including: a first sensor for detecting a first obstruction and positioned at an appropriate level on the support structure to detect a first cart portion passing the support structure; a second sensor for detecting a second obstruction and positioned at an appropriate level on the support structure to detect a second cart portion passing the support structure; and a controller that determines that a cart is present if the second sensor detects the second obstruction within a predetermined time of the first sensor losing detection of the first obstruction; an object detector provided to the support structure including: a third sensor for detecting a third obstruction and positioned at an appropriate level on the support structure to detect an object on the cart; a fourth sensor for detecting a fourth obstruction and positioned in proximity to the third sensor and at an appropriate level to detect the object on the cart; and a controller that determines that an object is present on the cart if the fourth sensor detects the fourth obstruction while the third sensor is detecting the third obstruction; and an alert device for alerting a user when an object is present and a cart is present.

In this embodiment, the cart sensors detect the transition from the first sensor to the second sensor, which assists with identifying the shape of the cart allowing the detection of a cart in motion rather than requiring the cart to be in a predetermined position. This embodiment also does not require the cart to be fitted with specialized reflectors or the like. Further, the use of two appropriately spaced object sensors prevents an object sensor from detecting an upward directed part of the cart.

In a particular case, the first, second, third and fourth sensors detect an obstruction if the obstruction is within a predetermined distance from the sensor. It is preferable if the sensors are set so that objects beyond a reasonable distance from the checkout counter are not detected.

In another particular case, the first and second sensors may further measure a distance to the first and second obstructions and the controller may further determine that a cart is present if the distance to the first obstruction is within a predetermined range of the distance to the second obstruction. That is, the controller may also use the additional evidence given by the distance measurements/data to make a determination that a cart is present. In this case, the cart detector may further include an additional sensor positioned between the first and second sensors for detecting an additional obstruction and for measuring a distance to the additional obstruction such that the cart controller further determines that a cart is present if the distance to the additional obstruction corresponds with the distance to the first obstruction and the distance to the second obstruction.

In yet another particular case, the third and fourth sensors may further measure a distance to the third and fourth obstructions and the object controller may further determine that an object is present if the distance to the third obstruction is within a predetermined range of the distance to the fourth obstruction. In this case, where a width of the cart is stored in the object controller, the first and second sensors may further measure a distance to the first and second obstructions, and the object controller may further determine that an object is present if the distance to the third obstruction or the distance to the fourth obstruction is less than the distance to the first obstruction plus the width of the cart or the second obstruction plus the width of the cart.

In yet another particular case, the controller may further determine that a cart is present if the second sensor does not detect an obstruction, that is, is clear of any obstruction, at some point while the first sensor detects the first obstruction.

In still yet another particular case, the first cart portion and the second cart portion are distinct elements of the cart based on a shape of the cart.

In still yet another particular case, the third and fourth sensors may only be activated when it is determined that a cart is present.

In still yet another particular case, the controller further determines that an object is present if the third sensor and the fourth sensor continue to detect the third and fourth obstructions for a predetermined period.

According to another embodiment of the invention, there is provided a method for detecting an object on a cart, including: detecting a cart, wherein the detecting a cart includes: detecting a first obstruction at a first sensor; detecting a second obstruction at a second sensor; and determining that a cart is present if the second sensor detects the second obstruction within a predetermined time of the first sensor losing detection of the first obstruction; detecting an object, wherein the detecting an object includes: detecting a third obstruction at a third sensor; detecting a fourth obstruction at a fourth sensor; and determining that an object is present on the cart if the fourth sensor detects the fourth obstruction while the third sensor is detecting the third obstruction; and then alerting a user when an object is present and a cart is present.

In a particular case, the first and second sensors may further measure a distance to the first and second obstructions and the determining that a cart is present may further include determining if the distance to the first obstruction is within a predetermined range of the distance to the second obstruction. As above, the determining that a cart is present uses the additional evidence/information from the distance measurements to decide whether or not a cart is present. In this case, the method may further include detecting an additional obstruction at an additional sensor such that the additional sensor measures a distance to the additional obstruction and wherein the determining that a cart is present further includes determining if the distance to the additional obstruction corresponds with the distance to the first obstruction and the distance to the second obstruction.

In another particular case, the third and fourth sensors may further measure a distance to the third and fourth obstructions and the determining that an object is present may further include determining if the distance to the third obstruction is within a predetermined range of the distance to the fourth obstruction. In this case, the first and second sensors may further measure a distance to the first and second obstructions and the determining that an object is present may further include determining if the distance to the third obstruction or the distance to the fourth obstruction is less than the distance to the first obstruction plus the width of the cart or the second obstruction plus the width of the cart.

In yet another particular case, the determining that a cart is present further includes determining that the second sensor does not detect an obstruction, that is, is clear of any obstruction, at some point while the first sensor detects the first obstruction.

In still yet another particular case, the first and second sensors are positioned to detect distinct elements of the cart based on a shape of the cart.

### BRIEF DESCRIPTION OF THE DRAWINGS

For a better understanding of embodiments of the invention, and to show more clearly how they may be carried into effect, reference will now be made, by way of example, to the accompanying drawings in which:

FIG. 1 is a diagram showing a side-view of a shopping cart of the type used with a system according to an embodiment of the present invention;

FIG. 2 is a diagram showing a schematic view of a check out lane incorporating a system according to an embodiment of the present invention;

FIG. 3 is a schematic diagram showing a circuit for use in a system according to an embodiment of the present invention;

FIG. 4 is a flowchart diagram of a method according to an embodiment of the present invention; and

FIG. 5 is a diagram showing an overhead view of a checkout lane incorporating a system according to an embodiment of the present invention.

### DETAILED DESCRIPTION

It will be understood by one of skill in the art that the system and method generally described herein can be applied to different types of carts and situations. However, for the purposes of example, the following embodiments will be described with regard to the detection of objects on a lower tray of a shopping cart.

Generally speaking, the embodiments relate to a system and method for detecting objects placed on the lower tray or rack of a shopping cart. The system uses a plurality of sensors positioned to detect the presence of the cart during checkout, generally within a checkout lane. Once a cart has been detected, object sensors are positioned to monitor the lower tray of the cart to determine if an object is present. In a preferred embodiment, the sensors are configured to determine the distance from the sensors to the cart and/or the distance from the sensors to the object. The system can thus determine relative locations of both the cart and the object, and can more accurately determine if an object is actually located on the cart by comparing the relative position of the cart to the relative position of the object. In a further preferred embodiment, the sensors can also track the movement of the cart down the checkout lane to provide more detailed monitoring of the cart and lower tray to detect items on the lower tray of various shapes, sizes and positions.

These and other features of various embodiments of the invention are discussed in greater detail below with reference to the appended Figures.

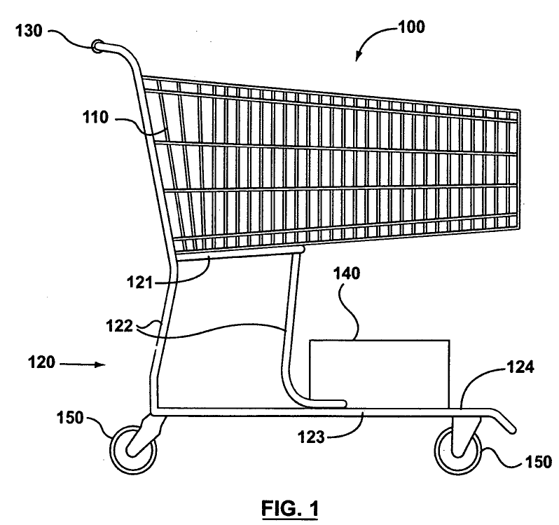

FIG. 1 is a diagram showing a side-view of a shopping cart 100 of the type used with a system according to an embodiment of the present invention. The shopping cart 100 includes a basket assembly 110 for holding items and a handle 130 for pushing the shopping cart 100. The handle 130 and basket assembly 110 are supported by a lower frame assembly 120. The lower frame assembly 120 is mounted to a plurality of wheels 150 that allow the shopping cart 100 to move relative to a ground surface. The lower frame assembly 120 typically comprises a first frame member 121, which is generally horizontal, for supporting the basket assembly 110, a second frame member 122, which is generally vertical, for supporting the first frame member 121, and a base frame member 123, which is generally horizontal, for supporting the second frame member 122 and for holding a tray support 124. The base frame member 123 also connects the lower frame assembly 120 to the plurality of wheels 150.

An object 140, which is often a large or heavy object, can be placed on the lower tray support 124 of the shopping cart 100 during use so that other objects may be placed in the basket assembly 110.

The sizing and spacing of the frame members of the lower frame assembly 120 can vary according to the requirements of a particular shopping cart 100, for example by being made larger to accommodate larger goods, or smaller to accommodate smaller goods. It will be appreciated by those skilled in the art that variations on the size and shape of the shopping cart 100 and the particulars of its design, including variations on the design of the lower frame assembly 120 can be taken into account and generally do not substantially affect the function of embodiments of the invention.

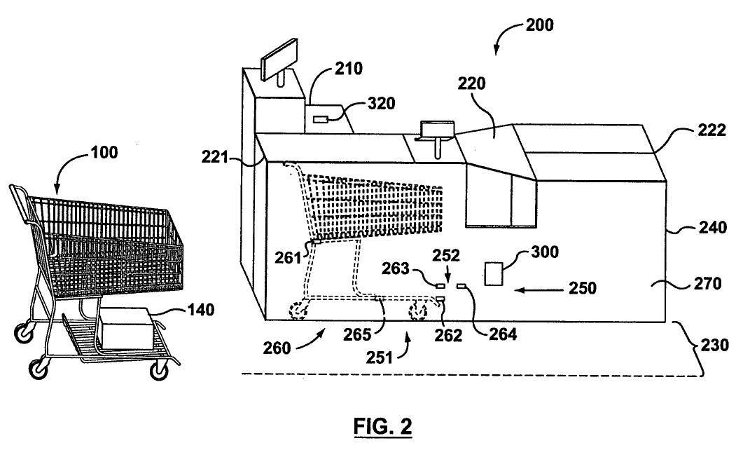

FIG. 2 is a diagram showing a schematic view of a check out lane incorporating a system according to an embodiment of the present invention. A checkout station 200 comprises a till 210 where a user, such as a cashier, can receive payments from a shopper purchasing goods. The till 210 may also include a scanner (not shown) for scanning bar codes associated with particular goods, a display (not shown) for displaying information to the cashier and a customer, a drawer (not shown) for storing money, and other components as desired as is known to those skilled in the art. The checkout station 200 also generally includes a conveyor 220 arranged to transport a customer's goods from a receiving end 221 to a finishing end 222. The finishing end 222 has an area used for example for bagging, or packing items into a shopping cart. The checkout station 200 also generally includes a checkout lane 230, which is wide enough to receive a shopping cart 100, and allow it to pass through the checkout lane 230 at time of checkout. The size of checkout lanes in various locations can vary depending on store layout.

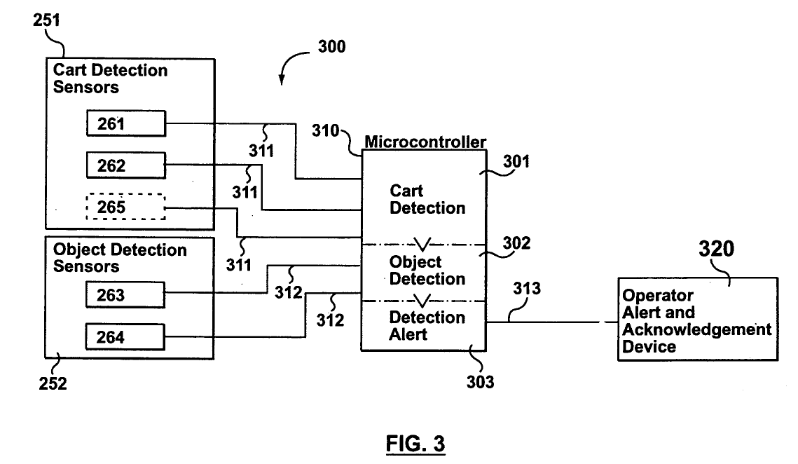

As shown in FIG. 2, the checkout conveyor 220 is generally supported by a checkout support frame 240, which also provides housing or a support structure for a detection system 250 according to an embodiment of the invention. The detection system 250 includes a plurality of sensors in a sensor network 260. The sensor network includes a cart detection system 251 with cart detection sensors 261, 262, and 265 for detecting the presence of a shopping cart 100 in the checkout lane 230, and an object detection system, including object detection sensors 263, and 264 for detecting the presence of an object 140 on the lower tray support 124 of the shopping cart 100. The detection system 250 also connects to a control device or control system 300, as detailed in FIG. 3. The sensors of sensor network 260 are generally mounted on a wall 270 of the checkout support frame 240 that faces outward towards the checkout lane 230 through which the shopping cart 100 passes.

In this embodiment, a first cart sensor 261 is mounted on the checkout support frame 240, generally nearer to the receiving end 221 of the checkout station 200 to detect objects entering the checkout lane 230, for example, a shopping cart 100. When the shopping cart 100 passes, the first cart sensor 261 detects an obstruction such as a portion of the cart, for example the first frame member 121. The first cart sensor 261 is positioned in order to detect a predetermined part of the type of cart 100 or carts generally used in the particular store. Preferably, the first cart sensor also measures the distance from the wall 270 to the first frame member 121, and the control system 300 records this value as a first cart distance. Although it is preferable to detect an actual distance between the wall 270, or first cart sensor 261, and an obstruction passing the first sensor (range sensing), it is also possible for the first sensor to detect obstructions that pass within a predetermined range of the sensor (proximity sensing). The first cart sensor 261 continues to detect an obstruction as the first frame member 121 moves along the checkout lane 230 and thus the first cart sensor tracks the movement of the first frame member 121 as it moves along the checkout lane 230. The control system 300 is thus able to determine when the first frame member 121 moves past the first cart sensor 261.

A second cart sensor 262 is positioned further along the checkout lane 230 such that it will detect a second portion of the cart 100, which may be the same portion or a different portion from that detected by the first cart sensor 261. Generally however the second cart sensor 262 will detect a different portion of the shopping cart 100, such as the base frame member 123.

Although both the first and second cart sensors could be positioned to detect the base frame member 123 of the cart 100, there is some benefit in having the first cart sensor 261 positioned to detect an upper frame member of the cart in that when detecting the upper frame member of the cart, there is less likelihood that the sensor might accidentally detect a continuing obstruction, such as a leg or foot, rather than a loss of detection of the upper frame member because the upper frame member is typically internal to the shopping cart in relation to the handle. This is in contrast to the base frame member 123 which is nearer to the floor and typically extends longer such that a foot placed next to the base frame member 123 might cause the first cart sensor 261 to continue to detect an obstruction even thought the base frame member 123 had moved away from the first cart sensor 261.

As with the first cart sensor 261, the second cart sensor 262 preferably measures the distance from the wall 270 to the base frame member 123 and the control system 300 records this information as a second cart distance. The second cart sensor 262 then generally tracks the base frame member 123 as the shopping cart moves along the checkout lane, and thus is able to determine when the base frame member 123 moves past the sensing beam of the second cart sensor 262.

As described in further detail below, the cart detection system 251 determines when a shopping cart 100 is present based on a timing or transition of obstructions from the first cart sensor 261 to the second cart sensor 262, and preferably also on a distance measurement analysis performed by the control system 300. Generally speaking, if the control system determines that obstructions pass each of the first and second cart sensors within a predetermined timing and each of the obstructions is within a predetermined range from the wall and/or from each other, then the control system 300 will determine that a cart is present. As such, the control system 300 can distinguish a shopping cart 100 from other obstructions, such as people walking through the checkout lane 230.

When the control system 300 detects the presence of a shopping cart 100 in the checkout lane 230, the control system 300 activates the object detection system 252. Alternatively, the object detection system 252 may operate continuously but the control system 300 will only signal an alarm when both a cart and object are detected.

The object detection system 252 comprises a first object sensor 263 and a second object sensor 264. The first object sensor 263 and the second object sensor 264 are positioned on the wall 270 for detecting an object 140 on the lower tray support 124 of the shopping cart 100 as it passes through the checkout lane 230 As with the cart sensors above, the first object sensor 263 and the second object sensor 264 each measure the distance from the wall 270 to the object 140. Again, the object sensors may also be proximity sensors rather than distance sensors.

Preferably, the first object sensor 263 and the second object sensor 264 are spaced such that the horizontal distance between them is larger than the width of elements of the cart 100 that may pass in front of the object sensors, such as the second frame member 122 of the shopping cart 100, such that when the shopping cart 100 passes by the object sensors 263, 264 it will not be detected by both object sensors 263, 264 concurrently. Conversely, the object sensors should not be spaced too far apart or thinner objects may be missed.

Optionally, an additional cart sensor 265 may also be provided on the wall 270 as part of the cart detection system 251 to improve detection of the cart, for example by increasing the number of timing or distance measurements of the base frame member 123 in order to better determine the shape of the shopping cart 100, and therefore the presence and also the positioning of the shopping cart 100 in the checkout lane 230. The provision of the additional cart sensor 265 can be used as an option to improve the accuracy of detection without overly increasing the cost or complexity of the system

While the object detection system 252 is active (i.e. when the control system 300 indicates that a cart 100 has been detected), if both object sensors 263, 264 detect an obstruction at approximately the same or a similar distance away and optionally within a predetermined period of time, the control system 300 determines that an object is present. The use of two object detection sensors 263, 264 helps eliminate the chance of false alarms that might be triggered by the second frame support member 122 passing through the sensor beam, or from various other anomalies in the shape or positioning of the shopping cart 100. It will be understood that additional object sensors may also be used in particular applications to increase accuracy at increased cost.

Preferably, the object sensors 263, 264 also compare the distance measured to the object 140 with one or more of the distances measured by the cart detection sensors 261, 262 to determine with greater accuracy that the object 140 is actually located on the shopping cart 100. A known width or average width of the shopping cart 100 can also be added to the distance measured to the cart 100 to obtain a maximum distance at which an obstruction should be detected as an object 140. In particular, the control system 300 determines if the distance to the object 140 measured by either sensor is generally less than the maximum distance. Since the object sensors 263, 264 measure distances as the object moves past, even if an object is hanging off of the cart, there will be a situation where the object distance measured is approximately within the range of the maximum distance. Comparing object distances to cart distances helps the control system 300 avoid false readings that may occur if an obstruction detected by the object sensors is actually beside the shopping cart 100, such as a leg 560 of a shopper or the like

Generally, the object detection system 252 continues to actively monitor for an object 140 on the lower tray 124 of the shopping cart 100 so long as the base frame member 123 of the shopping cart 100 is detected by the second cart sensor 262.

It should be noted that the orientation of the sensing beams of the sensors is generally parallel to the plane of the floor of the checkout lane 230 and normal to the plane of the wall 270, but may also be angled in one or more directions to account for particular measuring requirements.

A typical store may have any number of checkout stations 200, in a variety of configurations as will be appreciated by those skilled in the art.

FIG. 3 is a schematic diagram showing elements of a system according to an embodiment of the present invention. The control system 300 (as discussed above with regard to FIG. 2) generally includes a microprocessor or microcontroller 310 for controlling the system The microcontroller 310 also includes a cart detection module 301 for control and analysis of the cart detection system 251, an object detection module 302 for the control and analysis of the object detection system 252, and a detection alert module 303 for controlling and receiving input from an operator alert device 320.

The microcontroller 310 is in communication with the cart detection system 251 (and cart sensors 261, 262, and 265) via cart detection communication lines 311, with the object detection system 252 (and object sensors 263, 264) via object detection communication lines 312, and with an operator alert device 320 via detection alert communication lines 313.

The operator alert device 320 is activated by the microcontroller 310 to alert an operator that an object 140 has been detected on a shopping cart 100. The operator alert device 320 may also include an input device to receive operator acknowledgement and transmit such acknowledgement to the detection alert module 303. Although not illustrated in FIG. 3, the operator alert device 320 could be placed in the vicinity of the till 210 for easy access by the user or alternatively, the operator alert device 320 function could be incorporated into the till 210 and the microcontroller 310 could be in communication with the till 210.

It will be appreciated by those skilled in the art that a number of variations on control system 300 could be implemented without materially affecting the function of the invention. For example microcontroller 310 could be replaced with a microprocessor, or other control circuitry. Further the cart detection module 301, object detection module 302, and detection alert module 303, can be implemented as hardware or as software. The microcontroller 310 will also include memory (not shown) for storing software and data such as predetermined ranges, predetermined time periods, widths of cart types, and the like.

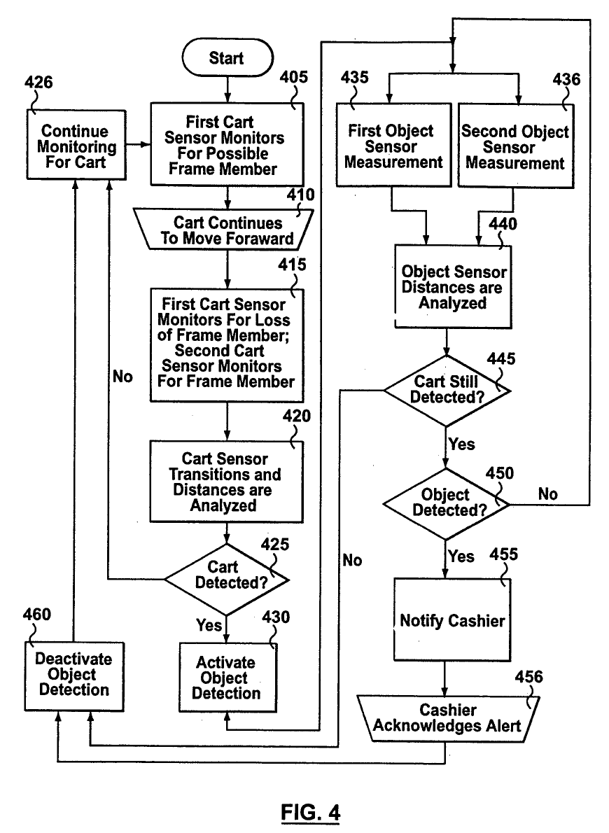

FIG. 4 is a flowchart diagram of a detection method 400 according to an embodiment of the present invention. Generally speaking, the detection method 400 determines whether a shopping cart is present in a checkout lane, activates object detection, determines if an object is present an a lower tray of the shopping cart, and activates an alarm if both a cart, and an object are detected to notify a checkout clerk to add the object to the purchases. It is preferable to activate the object detection system when a cart is present and then deactivate it when the cart is no longer detected in order to reduce the number of false alerts that may result as objects other than shopping carts pass through the checkout lane.

In step 405, a first cart censor detects an obstruction, which is believed to be a first cart portion of a shopping can passing through a checkout lane, such as the first frame member 121 of shopping cart 100 as shown in FIG. 1. Preferably, this detection is only considered a proper detection if at least second cart sensor 262, and further preferably object sensors 263, 264 are clear of obstructions, in order to help reduce false activations. During step 405, the first cart sensor also measures a first distance from the first cart sensor to the obstruction. During step 405, it is not clear whether a cart has actually been detected, or whether this is a different object passing though a checkout lane, such as a person walking through the lane.

In step 410, what is believed to be the shopping cart continues to move along the checkout lane. Generally, the first cart sensor 261 continues to detect the obstruction, which may be the first cart portion such as the first frame member 121, as it moves past the first cart sensor 261.

In step 415, the anticipated cart continues to move along the checkout lane until it moves past the first cart sensor 281 and the first cart sensor 261 no longer detects an obstruction. Within a generally short predetermined amount of time, a second obstruction, such as another cart portion, for example the base frame member 123 of the shopping cart 100 as shown in FIG. 1, obstructs the second cart sensor 262. As described above, the first cart sensor 261 and the second cart sensor 262 are positioned such that a cart 100 moving through the checkout lane 230 will result in this sequence of obstructions of the first cart sensor 261 and the second cart sensor 262 within a predetermined time period. As described, it is preferable that the cart sensors 281 and 262 be positioned such that as the first cart sensor 261 becomes clear, the second cart sensor 262 is obstructed in order to avoid error cases, such as, for example, where a cart is stopped and a person walks past the second cart sensor 262. The detection of this transition from the first sensor to the second sensor provides further evidence or clarification that a cart is present because it is less likely that random obstructions (such as legs or the like) will produce this same type of transition. The predetermined time period can be set according to the particular implementation but may be approximately 500 milliseconds from the first obstruction being lost by the first sensor until an obstruction is detected by the second sensor.

The second cart sensor 262 also measures a second distance from the second cart sensor 262 to the second obstruction. The second cart sensor then continues detecting the presence of the second obstruction as the cart continues to move along the checkout lane,

In step 420, the control system 300 analyzes the transition between the first and second cart sensors, and also preferably analyzes the first distance and the second distance as determined by the cart sensors, to determine whether or not a cart is present, i.e. whether the obstructions appear to be a first cart portion and a second cart portion. If the second cart sensor does not detect an obstruction within the predetermined time period, then the system determines that it was not a cart that was detected, and the system continues monitoring for carts. Otherwise, the system proceeds to check the distances. If the first and second distances are within a predetermined range, for example no greater than the width of the lane minus the width of the cart, this will be taken as an indication that a cart has in fact been detected. It will be appreciated by those skilled in the art that the particular predetermined range can be adjusted to accommodate different types and shapes of carts and checkout lanes to accommodate different angles of travel by the shopping cart along the checkout lane.

If an additional cart sensor is being used, such as additional cart sensor 265 as shown in FIG. 2, then the additional sensor may also detect an obstruction/cart portion, and determine a third distance which can be analyzed together with the first and second distances to further improve the accuracy of the system, and accommodate a greater variation in cart shapes, sizes and orientations. In particular, the third distance may be compared with the first and second distances to ensure that the distances correspond, for example, are in the same range or, in a particular case, to check that the three measurements are in a line or otherwise match with a cart shape.

Steps 415 and 420 generally allow different shopping carts with variations in design to be detected without needing to recalibrate the system for each cart type. In general, the use of a predetermined transition time between sensors detecting a cart portion, and the analysis of distance measurements. Increase the accuracy and reliability of the system in detecting carts.

In step 425, if the system wee unable to determine that a cart was present, for example if the transition timing or the distance measurements analyzed were outside the predetermined range specified, the system will be reset and will return to monitoring for carts at step 426. In an alternative embodiment, the system could alert a user that it was unable to tell if a cart was present, either through a display, an audio warning, or some other message, so that the user could know to manually determine whether a cart was present and look for an object on the lower tray.

At step 425, if a cart was detected, an object detection system is then activated, step 430, which will begin scanning for objects located on the lower tray of the cart.

Once active, the object detection system activated at step 430 will remain activate while the second cart sensor 262 continues to detect the second cart portion 123 on shopping cart 100. Once the second cart sensor no longer detects the second cart portion, the object detection system can be deactivity as discussed below at step 445.

In steps 435 and 436, a first object sensor and a second object sensor, for example object sensors 263 and 264 as shown in FIG, 2, monitor the lower tray region of the shopping cart as the lower tray passes by their sensor position. The first object sensor 263 and the second object sensor 264 each measure a distance to the nearest obstruction/object in line with each sensor, which is not necessarily an object on the cart, and the system proceeds to step 440.

At step 440, the distances measured by the first and second object sensors are compared to determine whether they are within a certain predetermined object range, such as the width of the checkout lane or closer than the far side of the lower tray. If the distances are within the object range, the system will determine that an object is present if the distances are not within the object range, then the system will determine that an object is not present. It will be appreciated by those skilled in the art that the object range can be calibrated according to the requirements of a particular implementation for example to accommodate the different types of products sold by a particular store, or for other reasons, and to accommodate different sizes and shapes of carts being used.

At step 445, a determination is made as to whether or not a cart is still being detected, by determining if the second cart sensor is still sensing an obstruction, which has previously been determined as the second cart portion. If the second cart sensor is still sensing the second cart portion, then the object detection system continues to monitor. However, if the second cart sensor is no longer detecting the second cart portion, then the object sensing system becomes inactive at step 460, and the detection system returns to monitoring for carts at step 426. As noted above, this step is optional but assists with reducing false alarm detections.

At step 450, if an object was not present during step 440, the system proceeds back to monitoring for objects at steps 435 and 436. However, at step 450, if the system determines that an object is present, the system proceeds to step 455 to notify a user, such as a cashier, that an object is present.

In step 455 the system alerts the user/cashier, to the presence of the object. This alert can be accomplished by a visual alarm on a display, an audio alarm, a vibration or other tactile notification, or some other method as contemplated by one of skill in the art.

At step 456, the user/cashier acknowledges the alert, for example by pushing a pushbutton or entering a code on the till or on a separate operator alert device. This acknowledgement deactivates the alert, and the system deactivates object detection at step 460, and returns to monitoring for carts at step 426. Alternatively, the system may also be linked to other systems that disable the shopping cart, or disable the till such that a checkout transaction cannot be completed until the cashier enters a product code or an override code, as is known in the art.

In a preferred embodiment of the invention, at step 440 of the method shown in FIG. 4, at least one of the distances measured by the object sensors are compared to at least one of the distances measured by the cart sensors. This allows the system to more accurately determine that an object is actually located on a cart. For example, the distances measured to the object should generally be less than the distances measured to the part plus the known width of the cart. If the distance measured to an obstruction is greater than the distance to the cart plus the width of the cart and remains so while being detected, this is an indication that the obstruction is not an object located on the cart, but rather may be between the cart and the opposite side of the lane, for example if a person is standing beside the cart.

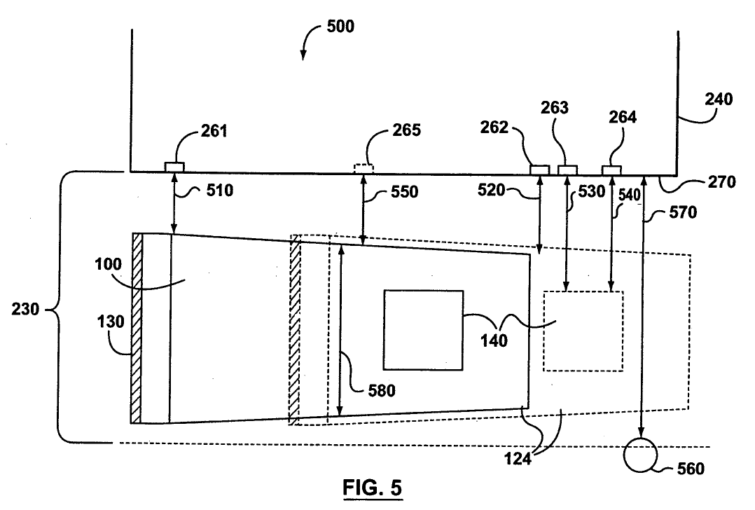

FIG. 5 is a diagram showing an overhead view of a checkout lane incorporating an object detection system 500 according to an embodiment of the present invention. FIG. 5 shows a shopping cart 100, having a handle 130, a lower tray 124 and an object 140 on the lower tray 124, being pushed along a checkout lane 230. The shopping cart is shown in two different positions as it moves through the checkout lane 230.

A plurality of sensors are provided on a wall 270 of a checkout support frame 240. The plurality of sensors include a first cart sensor 261, a second cart sensor 262, an optional additional cart sensor 265, a first object sensor 263 and a second object sensor 264. The cart sensors measure a first cart distance 510, a second cart distance 520, and an additional cart distance 550. The object sensors measure a first object distance 530 and a second object distance 540. A cart width 580 is the known approximate width of the cart, which is stored in a control system. In FIG. 5, an object 560 is shown beside the cart, which may be, for example, a person's leg, or some other obstruction.

In this embodiment, the detection system 500 compares the first cart distance 510 with the second cart distance 520 and the additional cart distance 550 to determine whether a cart is actually present. In this example, the distances are all within a predetermined threshold, and the system determines that a cart is present, thus activating the object detection system.

The object detection system compares the first object distance 530 with the second object distance 540 to determine if an object has been located. Here, both distances are within a predetermined threshold value, and an object has been located.

The system now compares at least one of the object distances 530, 540 to at least one of the cart distances 510, 520, 550. The system is thus better able to predict that an object 140 is actually located on the lower tray 124 of the shopping cart 100 Furthermore, the system now compares at least one of the object distances 530, 540 with a distance determined by adding one of the cart distances 510, 520, 550 to the cart width 580. The system is thus able to better determine that the object 140 is actually on the lower tray 124 of the shopping cart 100, and is not, for example, a person 560 walking beside the shopping cart 100 at a distance 570 beyond the range of the shopping cart 100. In this manner, the system is better able to reduce the number of false object detections.

In one embodiment of the invention, one or more of the sensors used in the sensor network 260 use reflection, and more particularly, are infrared (IR), range finding sensors, which operate by measuring the angle of reflection of the IR light that is emitted by and reflected back to them. The sensor emits modulated IR light and, in the same sensor, receives the light if it is reflected. The sensor input on the controller can be set such that the total range over which obstructions will be detected will be limited to, for example, less than the width of the checkout lane. An angle measurement is taken between emitted and received IR light resulting in a distance output. The preferred sensors are Sharp™ GP2D12(s) and a more detailed description of their operation can be found within the manufacturer's datasheets. The IR sensors output a voltage in relation to the distance of the object that they are detecting. This signal continues whether or not an obstruction/object remains in front of the sensor and, when an obstruction/object is detected, will vary based on the distance of the obstruction/object from the sensor if the obstruction/object is moving. The signal is then input into an analog to digital converter on a microcontroller for processing by the microcontroller. Although not required in all implementations, the use of an IR sensor of this type removes the need for reflectors or receivers or the like to be mounted on the opposite side of the checkout lane or on the cart. Although one particular type of sensor is described, it will be appreciated by those skilled in the art that other sensors are available and could be used without significantly affecting the operation of embodiments of the invention.

It will be understood by one of skill in the art that there may be situations in which sensors may briefly detect an obstruction in error. As such, preferred embodiments of the invention may include buffers to account for possible fluctuations in sensor values or the like.

The invention has been described with regard to a number of embodiments. It is not intended that the scope of the invention be limited to the specific embodiments illustrated and described. It will be understood by persons skilled in the art that other variants and modifications may be made without departing from the scope of the invention as defined in the claims appended hereto.

I claim:

1. A system for detecting an object on a cart, comprising:
a. a support structure;
b. a cart detector provided to said support structure comprising:
i. a first sensor for detecting a first obstruction and positioned at an appropriate level on said support structure to detect a first cart portion passing said support structure;
ii. a second sensor for detecting a second obstruction and positioned at an appropriate level on said support structure to detect a second cart portion passing said support structure; and
iii. a cart controller that determines that a cart is present if said second sensor detects said second obstruction within a predetermined time of said first sensor losing detection of said first obstruction;
c. an object detector provided to said support structure comprising:
i. a third sensor for detecting a third obstruction and positioned at an appropriate level on said support structure to detect an object on said cart;
ii. a fourth sensor for detecting a fourth obstruction and positioned in proximity to said third sensor and at an appropriate level to detect said object on said cart; and
iii. an object controller that determines that an object is present on the cart if said fourth sensor detects said fourth obstruction while said third sensor is detecting said third obstruction; and
d. an alert device for alerting a user when an object is present and a cart is present.

2. The system of claim 1, wherein said first, second, third and fourth sensors detect an obstruction if the obstruction is within a predetermined distance from said sensor.

3. The system of claim 1, wherein said first and second sensors further measure a distance to said first and second obstructions and wherein said cart controller further determines that a cart is present if said distance to said first obstruction is within a predetermined range of said distance to said second obstruction.

4. The system of claim 3, wherein said cart detector further comprises an additional sensor positioned between said first and second sensors for detecting an additional obstruction and a distance to said additional obstruction and said cart controller further determines that a cart is present if said distance to said additional obstruction corresponds with said distance to said first obstruction and said distance to said second obstruction.

5. The system of claim 1, wherein said third and fourth sensors further measure a distance to said third and fourth obstructions and wherein said object controller further determines that an object is present if said distance to said third obstruction is within a predetermined range of said distance to said fourth obstruction.

6. The system of claim 5, wherein a width of said cart is stored in said object controller, said first and second sensors further measure a distance to said first and second obstructions, and said object controller further determines that an object is present if said distance to said third obstruction or said distance to said fourth obstruction is less than said distance to said first obstruction plus said width of said cart or said second obstruction plus said width of said cart.

7. The system of claim 1, wherein said cart controller further determines that a cart is present if said second sensor is clear of any obstruction at some point while said first sensor detects said first obstruction.

8. The system of claim 1, wherein said first cart portion and said second cart portion are distinct elements of said cart based on a shape of said cart.

9. The system of claim 1, wherein said third and fourth sensors are activated only when it is determined that a cart is present.

10. The system of claim 1, wherein said object controller further determines that an object is present if said third sensor and said fourth sensor continue to detect said third and fourth obstructions for a predetermined period.

11. A method for detecting an object on a cart, comprising:
a) detecting a cart, wherein said detecting a cart comprises:
i) detecting a first obstruction at a first sensor;
ii) detecting a second obstruction at a second sensor; and
iii) determining that a cart is present if said second sensor detects said second obstruction within a predetermined time of said first sensor losing detection of said first obstruction;
b) detecting an object, wherein said detecting an object comprises:
i) detecting a third obstruction at a third sensor;
ii) detecting a fourth obstruction at a fourth sensor; and
iii) determining that an object is present on the cart if said fourth sensor detects said fourth obstruction while said third sensor is detecting said third obstruction; and
c) alerting a user when an object is present and a cart is present.

12. The method of claim 11, wherein said first, second, third and fourth sensors detect an obstruction if the obstruction is within a predetermined distance from said sensor.

13. The method of claim 11, wherein said first and second sensors further measure a distance to said first and second obstructions and wherein said determining that a cart is present further comprises determining if said distance to said first obstruction is within a predetermined range of said distance to said second obstruction.

14. The method of claim 13, further comprising detecting an additional obstruction at an additional sensor and said additional sensor measures a distance to said additional obstruction and wherein said determining that a cart is present further comprises determining if said distance to said additional obstruction corresponds with said distance to said first obstruction and said distance to said second obstruction.

15. The method of claim 11, wherein said third and fourth sensors further measure a distance to said third and fourth obstructions and wherein said determining that an object is present further comprises determining if said distance to said third obstruction is within a predetermined range of said distance to said fourth obstruction.

16. The method of claim 15, wherein said first and second sensors further measure a distance to said first and second obstructions and wherein said determining that an object is present further comprises determining if said distance to said third obstruction or said distance to said fourth obstruction is less than said distance to said first obstruction plus said width of said cart or said second obstruction plus said width of said cart.

17. The method of claim 11, wherein said determining that a cart is present further comprises determining that said second sensor does not detect an obstruction at some point while said first sensor detects said first obstruction.

18. The method of claim 11, wherein said first and second sensors are positioned to detect distinct elements of said cart based on a shape of said cart.

19. The method of claim 11, wherein said third and fourth sensors are activated only when it is determined that a cart is present.

20. The method of claim 11, wherein said determining that an object is present further comprises determining if said third sensor and said fourth sensor continue to detect said third and fourth obstructions for a predetermined period.
